(19) United States
(12) Patent Application Publication
(10) Pub. No.: US 2024/0211732 A1
(43) Pub. Date: Jun. 27, 2024

(54) MULTIVARIATE TIME SERIES FORECASTER USING DEEP LEARNING

(71) Applicant: THE TORONTO-DOMINION BANK, TORONTO (CA)

(72) Inventors: MATTHEW CARLTON FREDERICK WANDER, BLUE BELL, PA (US); HARSHUL VARMA, TORONTO (CA); HOLLY HEGLIN, TORONTO (CA); MING JIAN PAN, SCARBOROUGH (CA); ABINAV RAMESH SUNDARARAMAN, TORONTO (CA)

(21) Appl. No.: 18/213,624

(22) Filed: Jun. 23, 2023

Related U.S. Application Data
(60) Provisional application No. 63/435,055, filed on Dec. 23, 2022.

(51) Int. Cl. G06N 3/0455; G06N 3/0442; G06N 3/0464

(52) U.S. Cl. CPC G06N 3/0455; G06N 3/0442; G06N 3/0464

(57) ABSTRACT

Methods, systems and techniques for multivariate time series forecasting are provided. A dataset is obtained that corresponds to a multivariate time series data for a multivariate time series forecasting task. A particular machine learning architecture is used for the forecasting using an artificial neural network and deep learning. The machine learning architecture includes an autoencoder configured and trained on itself moved forward in time to generate autoencoder layers to analyse seasonality and co-variance information of the multivariate input dataset in a future time frame and an autoregressor to generate autoregressor layers to analyse trend information of the multivariate input dataset in a future time frame; and a layer merger for merging the one or more autoregressor layers and one or more autoencoder layers to form a set of merged layers representative of a multivariate time series forecast using the machine learning model in the future time frame.

### CROSS-REFERENCE TO RELATED APPLICATIONS

This application claims priority from U.S. Provisional Patent Application No. 63/435,055, filed on Dec. 23, 2022, and entitled “MULTIVARIATE TIME SERIES FORECASTER”, the entire contents of which are hereby incorporated by reference herein.

### FIELD

The present disclosure relates to systems and methods for automatically providing multivariate time series forecasting via a computer-implemented deep learning model including a multi-layered machine learning model.

### BACKGROUND

Multivariate time series forecasting plays a crucial role in various domains where accurate predictions are required. Traditional time series forecasting methods often fall short when dealing with multivariate data, which involves multiple variables or features evolving over time. One need arises from real-world computerized systems that generate large amounts of real world data with intricate interdependencies among a number of variables. To capture complex relationships and interactions, there is a demand for advanced computerized techniques that can process disparate sources of real-time and dynamic information and provide accurate multivariate time series forecasting.

Multivariate time series forecasting generally presents technological challenges, which current methods such as statistical models and univariate models do not adequately address. Current approaches for multivariate metric forecasting using univariate computer models and statistical models are limited to single variable prediction, which limits accuracy when providing time-series forecasts for complex computing systems which process large amounts of data on a real time basis and cannot account for the multivariate dependencies in input data.

For example, baseline models can quickly overfit and become poor at fine scale capturing of information. Statistical models require very complex tuning and pre-processing, thereby wasting computing resources and still lack ability to account for multiple variables as the data size grows. Traditional approaches using single variable methods are not capable of predicting fundamental behaviours of multivariate real world data, such as correlative effects, which decreases the accuracy of the predictions. Computer-implemented univariate models also require extensive data preprocessing as well as manual intervention to implement and monitor thereby leading to inability to scale and inaccurate results.

In addition, current approaches to time series forecasting using the aforementioned methods cannot provide robust time series multi-variable forecasting with shallow and/or wide data, which is a significant problem when processing certain types of data using computerized methods.

Thus there exists a need for an improved computerized system and architecture which leverages the power of deep neural networks with ability to capture complex data relationships and adapt dynamically to real world data to provide dynamic multivariate time series forecasting.

### SUMMARY

In at least some aspects, the proposed disclosure provides an improved computerized system, method, device and architecture which seeks to leverage the power of deep learning models for multivariate time series forecasting, for use across various fields for dynamic and real time series forecasting. By providing an improved machine learning system architecture which combines the power of deep neural networks with the ability to capture complex relationships and adapt to changing patterns, the proposed disclosure, system and method conveniently offers significant technological advancements over existing techniques and systems, including existing machine learning models. Conveniently, the proposed specialized deep learning model architecture provides an improvement over existing models and provides accurate and robust forecasting capabilities, opening up new possibilities for computing resource optimization, and improved operational computer efficiency and accuracies, for use across a range of industries.

The applications of multivariate time series forecasting are extensive and can be found in domains such as finance, energy, healthcare, manufacturing, transportation, weather and climate, as well as Internet of Things (IoT), and sensor networks.

Deep learning models offer significant advantages over traditional methods for multivariate time series forecasting. These models excel at learning complex patterns and dependencies within data, making them particularly suitable for handling high-dimensional time series data. Unlike conventional models, deep learning models can automatically extract features from raw data, reducing the need for manual feature engineering. By leveraging deep neural networks, the currently proposed machine learning models are capable of capturing intricate nonlinear relationships and adaptively learning from the input data. Thus in at least some aspects, the proposed describes a particular specialized machine learning architecture and system for improved multivariate time series forecasting using deep neural networks which process multivariate time series data and capture multivariate time series characteristics such as seasonality, trend and covariance.

Traditional methods face challenges when it comes to capturing the intricate and nonlinear relationships present in large-scale time series data. Traditional methods are focused at univariate modelling and are unable to capture the unpredictable nature of multivariate data.

Thus, it is desirable, in at least some aspects, to provide computer systems and methods, specifically configured to provide an improved computing architecture and specialized machine learning implementation which generate multi-variate time series forecasts such as from shallow input data for subsequent action and interaction via a computer implemented network. In addition, it is desirable that such computer systems and methods incorporate the fundamental behaviours of the underlying data including but not limited to: trend, seasonality, and correlative effects, to automatically generate multivariate time series forecast predictions with increased precision and accuracy.

The disclosure also relates, in at least some implementations, to creating a computer-implemented multivariate time series forecaster using deep learning models that can outperform any single variate model.

One example application is for economic data forecasting as the multivariate input data such as to improve forecasting of liquidity, but the forecaster is intended, in at least some aspects, to work on any type of multivariate data whereby there is a possible presence of interdependencies between different time series of input data and such data may be obtained from a variety of computing devices, servers, vehicles, and sensors (e.g. such as for vehicle traffic management, or internet of things (IoT) management).

Forecasting multivariate time series data is a challenging task. Current approaches for multivariate metric forecasting, such as for financial data, weather data, traffic patterns, computer network patterns or other multivariable time series using univariate modelling are limited to single variable prediction, which limits accuracy, reliability, scalability when providing time-series forecasts for complex systems such as multi variable data and they are unable to detect unpredictable event occurrences or anomalies.

In addition, current approaches using single variable methods are not capable of predicting fundamental behaviours of dynamically changing multivariate data such as correlative effects, and have limited effectiveness when applied to shallow datasets.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer implemented method for providing multivariate time series forecasting of input data having multiple variables using deep learning models. The computer implemented method also includes receiving a time series of a multivariate input dataset on a sliding window of time. The method also includes providing the multivariate input dataset in a defined window to a machine learning model using deep learning to predict future values of the dataset in a future time frame, the machine learning model being trained based on a historical data set where the historical data set having more data points in a past time frame than the future time frame being predicted, and wherein predicting with the machine learning model further may include: utilizing an autoencoder provided within the machine learning model to generate one or more autoencoder layers to analyse seasonality and co-variance information of the multivariate input dataset; implementing an autoregressor within the machine learning model to generate one or more autoregressor layers to analyse trend information of the multivariate input dataset; implementing one or more layer mergers within the machine learning model to receive the trend information from the one or more autoregressor layers and the seasonality and the co-variance information from the one or more autoencoder layers; merging the one or more autoregressor layers and one or more autoencoder layers within the one or more layer mergers to form a set of merged layers; and automatically generating a multivariate time series forecast using the machine learning model in the future time frame based on the set of merged layers.

Other embodiments of this aspect include corresponding computer systems, apparatus, and computer programs recorded on one or more computer storage devices, each configured to perform the actions of the methods.

Implementations may include one or more of the following features. The method may include: stationarizing the multivariate input data as received and prior to providing the multivariate input dataset to the machine learning model, applying the sliding window to the multivariate input dataset of available historical time series data further may include: designating a time portion of the time series of the multivariate input dataset as a training set for the machine learning model and another time portion of the multivariate input dataset as dropped data being ignored during a training phase of the machine learning model and a future time portion as a forecasted set for being generated by the machine learning model.

The autoencoder of the machine learning model further may include an encoder and a decoder, the decoder to process seasonality and co-variance information received from one or more autoencoder layers and configured to flatten layers of data provided from the encoder into a same dimension as an expected output shape from the machine learning model so as to be merged with an output of the autoregressor.

The autoencoder is configured with a convolutional neural network to provide multivariate time series forecasting by being applied in an iterative manner where initially receives a window of historical time series data in the multivariate input data set for encoding and decoding, while at subsequent iterations, the decoder is tuned to use its own output as an input for a subsequent time step thereby generating forecasted seasonality and covariance for future time steps. The autoencoder in the machine learning model further may include a bottleneck layer located between the encoder and the decoder, the bottleneck layer being a lower dimensional hidden layer having a least amount of neurons where the encoding is produced, and the encoder applying a dilated convolutional neural network. The autoencoder applies one of a dilated convolutional neural network (CNN), a long short term memory (LSTM) network, and other neural networks using convolutional layers. The multivariate input dataset received at the machine learning model may include one or more multivariate time series forecasts previously automatically output by the autoencoder of the machine learning model. The machine learning model is further configured to perform granger causality feature selection on received input data may include the multivariate input dataset to predict an efficacy of utilizing a particular variable of the multivariate input dataset to predict a separate forecasted multivariate time series data with a change in time period.

Implementations of the described techniques may include hardware, a method or process, or computer software on a computer-accessible medium.

One general aspect includes a non-transitory computer readable medium having instructions tangibly stored thereon. The non-transitory computer readable medium also includes receive a time series of a multivariate input dataset on a sliding window of time. The medium also includes provide the multivariate input dataset in a defined window to a machine learning model to predict future values of the dataset in a future time frame, the machine learning model previously trained based on a historical data set where the historical data set having more data points in a past time frame than the future time frame being predicted, where predicting with the machine learning model further may include. The medium also includes utilizing an autoencoder provided within the machine learning model to generate one or more autoencoder layers to analyse seasonality and co-variance information of the multivariate input dataset. The medium also includes implementing an autoregressor within the machine learning model to generate one or more autoregressor layers to analyse trend information of the multivariate input dataset. The medium also includes implementing one or more layer mergers within the machine learning model to receive the trend information from the one or more autoregressor layers and the seasonality and the co-variance information from the one or more autoencoder layers. The medium also includes merging the one or more autoregressor layers and one or more autoencoder layers within the one or more layer mergers to form a set of merged layers; and. The medium also includes automatically generating a multivariate time series forecast using the machine learning model in the future time frame based on the set of merged layers.

Other embodiments of this aspect include corresponding computer systems, apparatus, and computer programs recorded on one or more computer storage devices, each configured to perform the actions of the methods. One general aspect includes a computer system for providing multivariate time series forecasting of input data having multiple variables using deep learning models. The computer system also includes a processor in communication with a storage, the processor configured to execute instructions stored on the storage to cause the system to: receive a time series of a multivariate input dataset on a sliding window of time; provide the multivariate input dataset in a defined window to a machine learning model to predict future values of the dataset in a future time frame, the machine learning model being trained based on a historical data set where the historical data set having more data points in a past time frame than the future time frame being predicted, where predicting with the machine learning model further may include: utilizing an autoencoder provided within the machine learning model to generate one or more autoencoder layers to analyse seasonality and co-variance information of the multivariate input dataset. The system also includes implementing an autoregressor within the machine learning model to generate one or more autoregressor layers to analyse trend information of the multivariate input dataset. The system also includes implementing one or more layer mergers within the machine learning model to receive the trend information from the one or more autoregressor layers and the seasonality and the co-variance information from the one or more autoencoder layers. The system also includes merging the one or more autoregressor layers and one or more autoencoder layers within the one or more layer mergers to form a set of merged layers; and automatically generating a multivariate time series forecast using the machine learning model in the future time frame based on the set of merged layers.

Other embodiments of this aspect include corresponding computer systems, apparatus, and computer programs recorded on one or more computer storage devices, each configured to perform the actions of the methods.

According to another aspect, there is provided a computer system comprising: a processor; a non-transitory computer readable medium communicatively coupled to the processor and having stored thereon computer program code that is executable by the processor and that, when executed by the processor, causes the processor to perform the method of any of the foregoing aspects or suitable combinations thereof.

The system may also comprise a memory communicatively coupled to the processor for storing the input and output multivariate dataset.

There is provided a computer program product comprising a non-transient storage device storing instructions that when executed by at least one processor of a computing device, configure the computing device to perform in accordance with the methods herein.

### BRIEF DESCRIPTION OF THE DRAWINGS

These and other features will become more apparent from the following description in which reference is made to the appended drawings wherein:

FIG. 1A shows an example block diagram of a machine learning model architecture including example computing components for providing a multivariate time series forecaster, in accordance with an embodiment of the present disclosure.

FIG. 1B shows an example block diagram of an example implementation and method for multivariate time series forecasting using the machine learning model architecture of FIG. 1A, in accordance with an embodiment of the present disclosure.

FIG. 2 is a block diagram of an example computer system that may be used to perform multivariate time series forecasting, in accordance with an embodiment of the present disclosure.

FIGS. 3A-3B show an example visualization of a stack of causal convolutional layers and of a stack dilated causal convolutional layers, respectively, for use with the machine learning model architecture of FIGS. 1A-1B and in accordance with an embodiment of the present disclosure.

FIGS. 4A-4C show example graphs of trend, seasonality and correlative effects data, as may be extracted by the machine learning model architecture of FIGS. 1A-1B, and the computing system of FIG. 2 in accordance with an embodiment of the present disclosure.

FIG. 5 shows an example sliding window for splitting training/forecasting dataset for the machine learning model architecture of FIG. 1A or 1B in accordance with a further embodiment of the present disclosure.

FIG. 6 illustrates an example graph relating to architecture and regularization, and root mean square error for different machine learning models, in accordance with a further embodiment of the present disclosure.

FIG. 7 is an example graph illustrating net product growth and a comparison of actual growth to different types of projection modelling including multivariate modelling, in accordance with a further embodiment of the present disclosure.

FIG. 8 illustrates another example graph comparing actual growth to different prediction modelling techniques for forecasting time series including multivariate, in accordance with a further embodiment of the present disclosure.

FIG. 9 illustrates an example structure of multivariate data, e.g. shallow data, available for forecasting such as by the machine learning model structure of FIG. 1A, or FIG. 1B in accordance with a further embodiment of the present disclosure.

FIG. 10 illustrates a time series graph in relation to granger causality feature selection, as may be performed by the machine learning model structure of FIG. 1A, or FIG. 1B in accordance with a further embodiment of the disclosure.

FIG. 11 illustrates a schematic of an example series of samples of multivariate time-series data which may be output by the machine learning model structure of FIG. 1A, in accordance with a further embodiment of the disclosure.

FIG. 12 illustrates a schematic of a flowchart illustrating example operation performed by the computer system, e.g. the multivariate time series forecaster machine learning model of FIGS. 1A, 1B or the computing device of FIG. 2, configured for performing multivariate time series forecasting using deep learning.

### DETAILED DESCRIPTION

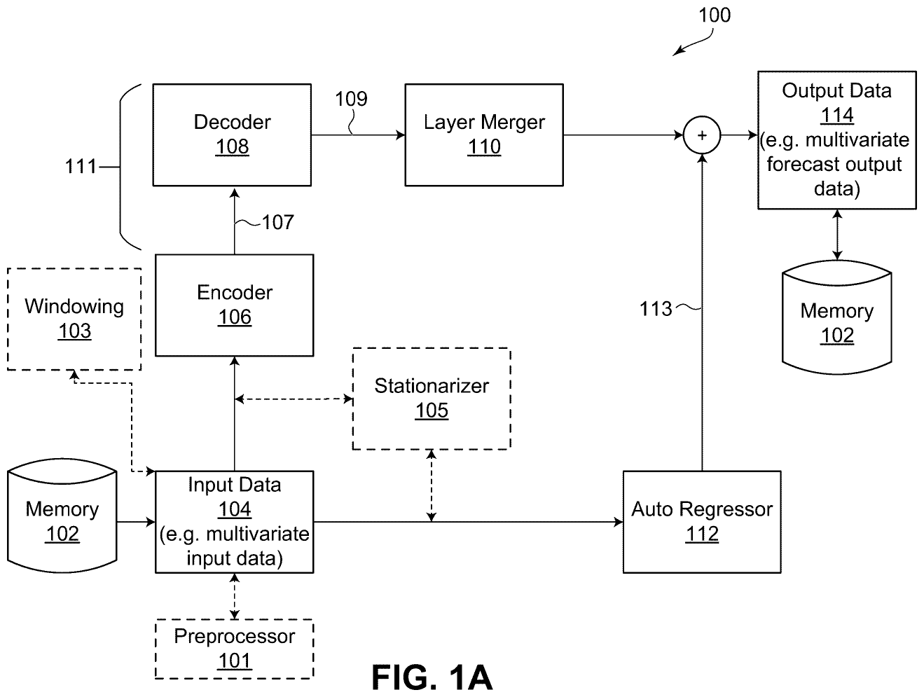

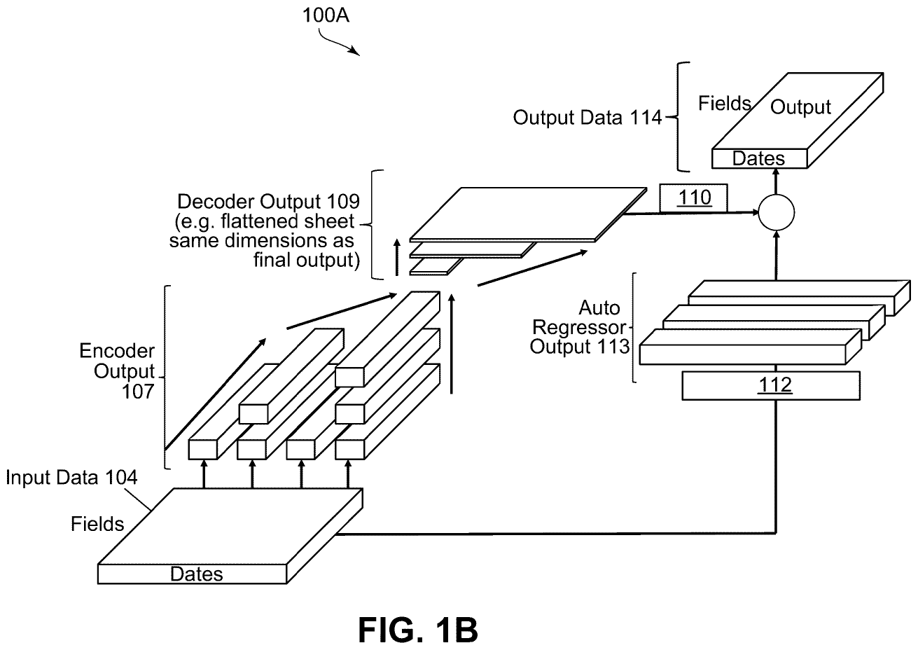

In at least some aspects and referring generally to FIGS. 1A and 1B, there is provided an improved computerized multi-variate time series forecaster machine learning model 100 (referred to also generally herein as multi-variate machine learning model 100 or generally as machine learning model 100) as well as associated computing environment as shown in FIG. 1A using deep learning form of machine learning which uses the deep multi-layered architecture of a deep neural network to provide forecasting of future time series values (e.g. in the form of output vectors) of a plurality of variables including capturing correlative effects of the input data. Referring to FIG. 1B, shown is an example implementation use of such machine learning model, shown as example implementation 100A along with example outputs and data shapes provided at various stages of processing the data within the machine learning model 100 of FIG. 1A.

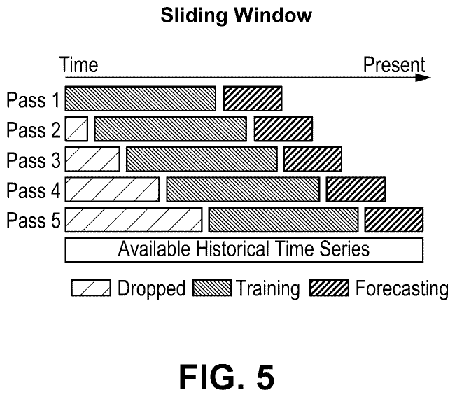

As shown in FIG. 1A, the machine learning model 100 comprises an encoder 106, a decoder 108, an autoregressor 112 and a layer merger 110. The machine learning model 100 may further optionally comprise one or more of: a preprocessor 101, a windowing 103 module, and a stationarizer 105. An input data 104 set including multivariate time series input data may be fed into, obtained or otherwise accessed by the machine learning model 100. The model 100 makes use of a database, such a memory 102 which may store data for training, testing, validating the model, an example method of splitting such available historical time series data which may be stored on the memory 102 shown in FIG. 5.

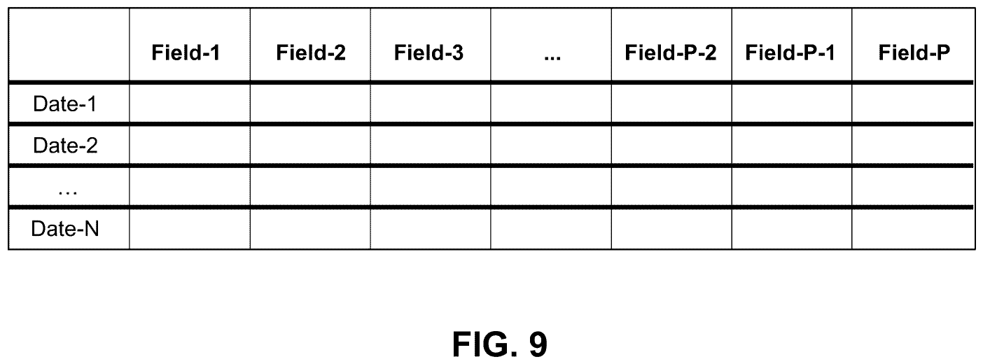

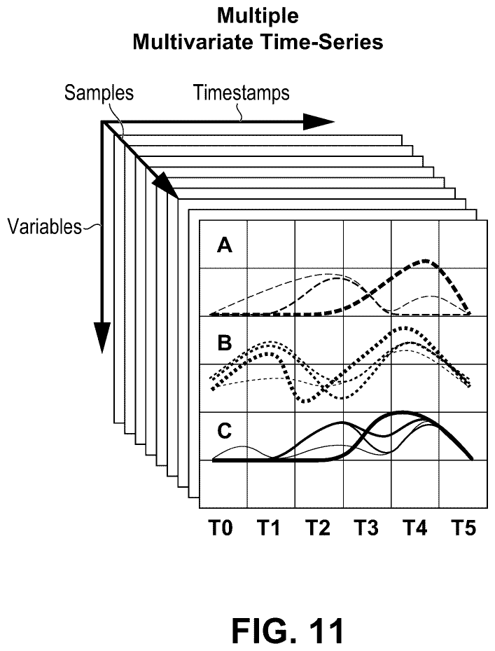

The input data 104 is a multivariate time series input data set, which may comprise two or more time dependent variables and each variable (or field as shown in FIG. 9) not only depends on its past values but also may have some dependency on other variables in the time series input data (e.g. Field-1 and Field-2 may have some dependency on one another). Values for all fields shown in FIG. 9 may have been captured from Date-1 to Date-N. Similarly, the forecasted time series output data, provided by the model 100 is shown as output data 114. An example visualization of multiple output multivariate time series having a number of samples, variables and time stamps is depicted in FIG. 11. The model 100 may utilize the memory 102 to store the output data 114, including set of time samples of multiple variables having values predicted into a future time period. Put another way, as described herein, a multivariate time series may refer, at a high level to a dataset where two or more time series variables are observed at a given time as shown in FIG. 9, by way of example. Additionally, in at least some aspects, each variable depends not only on the historical values but also has dependency on other variables in the dataset.

Some domains in which multivariate time series forecasting may be applied include real world applications whereby large amounts of complex real time data are obtained from multiple computerized networked systems, computerized sensors, vehicles, devices and databases, which can include financial data forecasting, weather data forecasting, traffic pattern and occupancy data forecasting, computer resource management, dynamic system analysis, Internet of things data forecasting, etc.

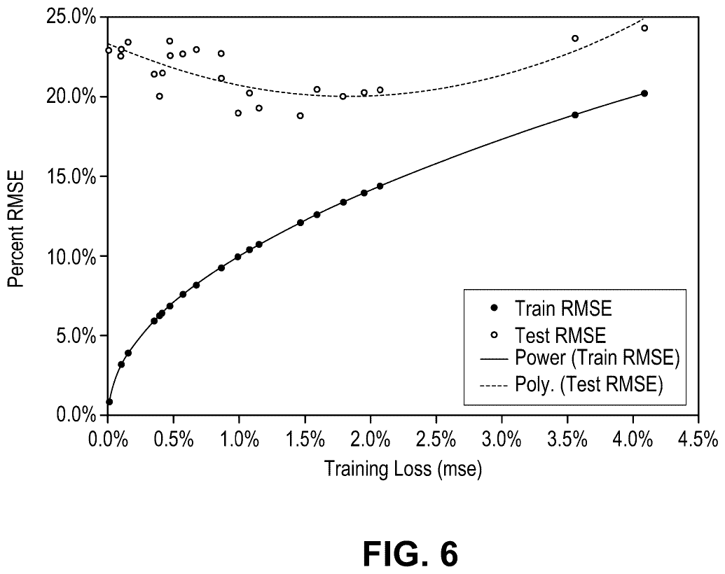

FIG. 6 illustrates an example output graph of percent root mean squared error RMSE versus training loss MSE (mean squared error) as determined during architecture and regularization phase of model development.

In at least some implementations, the proposed computerized multi-variate time-series forecaster model architecture shown as the machine learning model 100 and example implementation 100A of the machine learning model in FIGS. 1A and 1B improves upon existing computerized machine learning and deep learning techniques by utilizing a unique and particular deep learning computing architecture comprising a plurality of underlying deep learning models as shown in FIGS. 1A and 1B specifically configured to cooperate together in a particular manner so as to perform the time series multivariate forecasting using, in some aspects, additive model(s) which learn nonlinear trends, seasonality and covariance and can incorporate second data effects.

Referring to FIGS. 1A and 1B, the multi-variate time series forecaster machine learning model 100 or example implementation 100A (also may be referred generally herein to as a machine learning model or a multi-variate machine learning model) comprises a specialized autoencoder 111 to gather seasonality and covariance information into a future time frame for the time series multivariate input data set comprising a number of data samples over time, shown as input data 104 and an autoregressor 112 specifically tuned for extracting trend information in the future time frame from the multivariate input data set, e.g. input data 104. The machine learning model 100 merges the layers of information gathered from both the autoencoder 111 and the autoregressor 112, as shown in FIG. 1B, via a layer merger 110) to provide multivariate time series forecasting output. As illustrated, this is performed by merging the layers provided by the different components as predicted by the autoregressor 112 (see autoregressor output 113) and the autoencoder 111 (see encoder output 107 generated from the input data 104 and correspondingly generated decoder output 109 being combined with the autoregressor layers from output 113). In at least some aspects, the same input multivariate time series data set, shown as the input data 104 is provided to both the autoencoder 111 and the autoregressor 113. In some aspects, additional preprocessing may be performed on the data prior to reaching the encoder 106 or the autoregressor 112 such as via the preprocessor 101, the stationarizer 105 and/or the windowing 103.

In at least some aspects, the autoencoder 111 predicts data not on itself but is configured rather, on itself moved forward in time, using a convolutional neural network (e.g. CNN). Conveniently, this allows the machine learning model 100 to address shallow and wide data issues, which in some cases may be all the data that is available for forecasting and contrary to typical deep learning as there may be data from a predefined number of features. An example of such shallow data which may be received as the multivariate input data 104 is shown in FIG. 9, in which the variable “P” shown as the field size or number of variables exceeds the number of date samples “N”, such that P>>N. As may be envisaged, in some example implementations, forecasting multi-variate shallow data presents issues in deep learning and thus, the proposed methods help alleviate at least some of such issues by configuring the machine learning model 100 such that the number of output data points of future time values for the time series are smaller than the number of input data points of historical time values. The windowing technique described herein which partitions the datasets into subsections using rolling windows, increases the dimension shape of the dataset.

In one example implementation and referring to FIG. 1A, the autoencoder 111 model (e.g. LSTM based autoencoder or convolutional neural network based) may be trained on itself moved forward in time, that is, it may be provided with a source and target time series data sequences where the autoencoder 111 model considers both the source and a shifted version of the target sequence as input (e.g. provided to the decoder) and then the decoder 108 may predict the next time step of the target sequence. Thus put another way, in one example implementation, the encoder 106 is configured to bottleneck current information (e.g. current time window of information) into a latent space representation and then makes a projection using the decoder 108 by pushing the data forward in time and predicting the next time step of the multivariate input dataset. Simply put, the encoder 106 and decoder 108 combination cooperates together to project from a past time frame of multivariate input data to a future time frame. For example, the encoder 106 may be used to learn patterns in the historical time series input data and provide such information to a bottleneck layer between the encoder 106 and the decoder 108 (not shown), such as to gather seasonality and covariance information. The decoder 108 may be configured to use the bottleneck information to forecast future multivariate time series, shown as the decoder output 109.

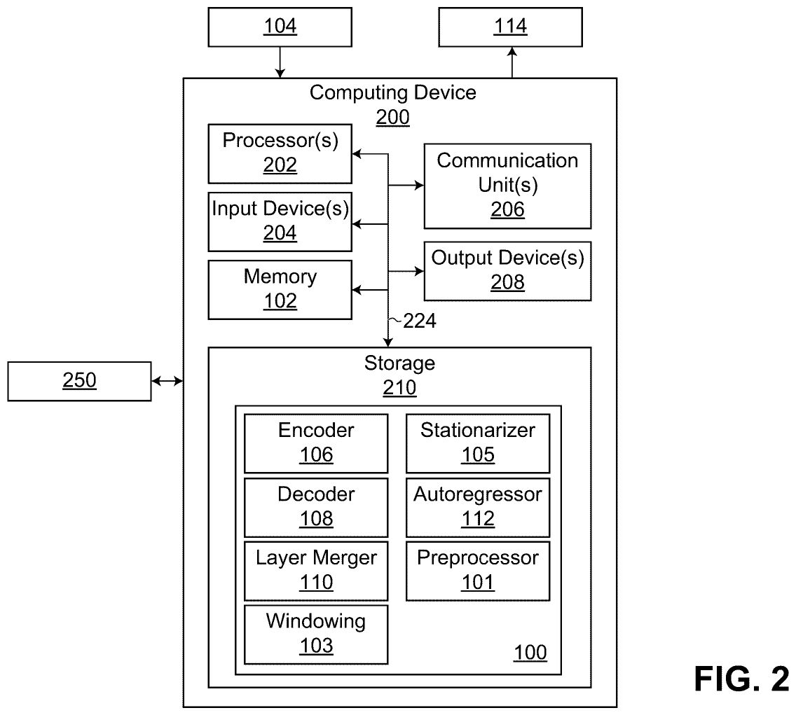

In one specific implementation, during the inference phase, the historical input time series multivariate data may be fed into the encoder 106 to obtain the context vector. Then, in such implementation, the machine learning model 100 applies the context vector as an initial hidden state for the decoder 108, and the decoder may be run repeatedly such as to generate future time step predictions for the multivariate input data as the decoder output 109. The machine learning model 100 may then be configured, in this implementation, via a processor shown in FIG. 2 to iterate this process to forecast multiple time steps into the future for subsequent merging with the autoregressor output 113.

Thus, in at least some aspects, the autoencoder 111 cooperating with the autoregressor 112 provides the ability to track metrics such as seasonality, trend and covariance forward in time and enables making prediction beyond unpredictable events.

An aspect of the embodiment of the disclosed computer method, the machine learning model 100 of FIG. 1A is trained on the stationarized historical transaction data to automatically generate multivariate time-series forecasts. In at least some aspects, the input data 104 may be initially stationarized via a stationarizer 105. One concern is that if there is a trend from the training set to the test sets as provided to the machine learning models (e.g. the autoencoder 111 and/or autoregressor 112) then the model 100 could learn that trend and potentially overfit the testing set (see examples of training/testing set splits from the available historical time series data in FIG. 5). Two ways to make a non-stationary data set stationary by way of the stationarizer 105 shown in FIG. 1A is for the machine learning model 100 to apply differencing, such as via the processor 202 of FIG. 2 to compute the differences between consecutive observations and percent differencing. This way, differencing can help stabilize the mean of the input time series by therefore eliminating or at least reducing trend.

In one implementation, sliding windows are applied to the input data set by way of the windowing 103 computing block in the machine learning model 100 of FIG. 1A. At a high level, the windowing 103 block applies sliding windows to the available historical time series data shown as the input data 104. Windowing generally refers to herein as taking a dataset and partitioning it into subsections thereby increasing the dimensionality shape of the dataset. In one example implementation, the windowing technique is applied as a sliding window as shown in FIG. 5, such that in each subsequent pass, the training data and the testing/forecasting/validation data is time shifted from the prior pass of the data. Some of the data is then dropped that occur due to the data shifting from the prior iteration (e.g. see pass 2 as compared to pass 1; or pass 3 compared to pass 2). Windowing in general may refer to the windowing 103 block using prior time steps to forecast the next time step, as will be described herein. The sliding window, an example of which is shown in FIG. 5, as applied by the windowing 103 bring data stability and utilization to the machine learning model 100. Additionally, such windowing is important as deep learning models utilized by the model 100 require fixed shape inputs.

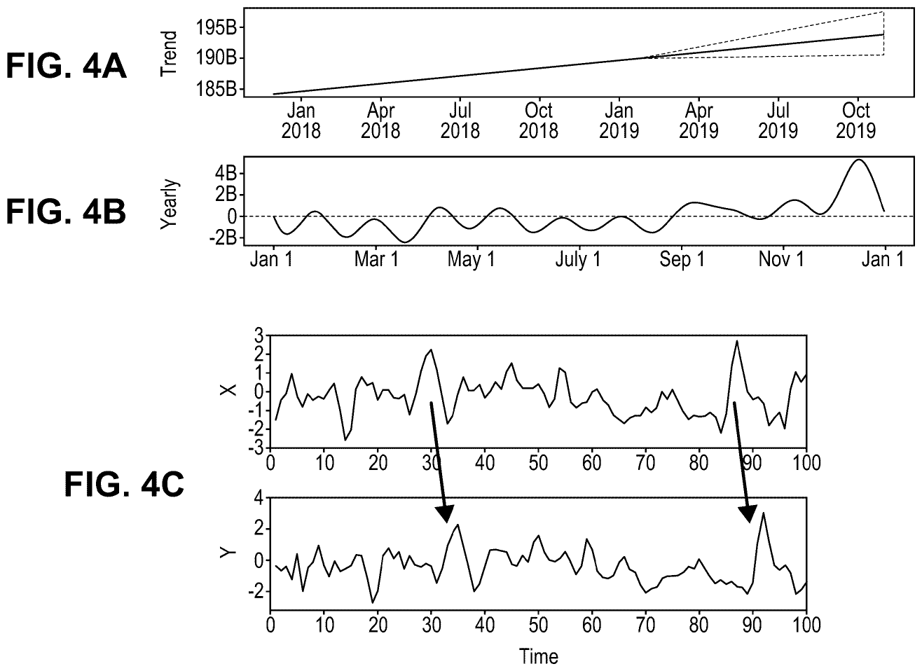

Referring again to FIGS. 1A and 1B, the machine learning model 100 (an example implementation 100A of which is shown in FIG. 1B) uses autoencoder layers (e.g. see encoder output 107 and decoder output 109 of FIG. 1B) and autoregressor layers (e.g. see autoregressor output 113) to determine seasonality information, co-variance information and trend information respectively and to automatically provide multivariate time series forecasts. Put another way, the model 100 (or the example implementation model 100A) provides prediction by incorporating fundamental behaviours of the underlying data. Examples of such components of data are shown in FIGS. 4A-4C. FIG. 4A illustrates the trend component, FIG. 4B illustrates the seasonality component and FIG. 4C illustrates correlative effects between variables which can only be computer with multivariate models such as the model 100 (or example implementation 100A of the model shown in FIG. 1B).

Referring again to the machine learning model 100, in operation, it predicts three components or characteristics of the multivariate input data: trend which includes overall trend of the data or change of behaviour over time; correlative effects which include how one variable affects another variables and relationship between two different fields; and seasonality which is another characteristic of time series data in which the data experience regular (e.g. weekly, monthly, season based) and predictable change that recur in a given time period.

Referring again to FIG. 1A, the autoencoder 111 comprises at least an encoder 106 and a decoder 108 (as well as a bottleneck layer, not shown, located between the encoder 106 and the decoder 108 to provide a latent space representation of the data and used compress information through the bottleneck). The autoencoder 111 is specifically configured not on itself but on itself moved forward in time, thereby building a bridge from a present tense of information (e.g. vector of input variables and values over time) into the future time. Put another way, in at least some aspects, the autoencoder 111 is configured such that the information of a present time is funneled into a bottleneck but instead of putting it back onto itself, the information is pushed out forward in time which allows the encoder 106 cooperating with the decoder 108 through the bottleneck to predict the multivariate time series output shown as decoder output 109 in a future time.

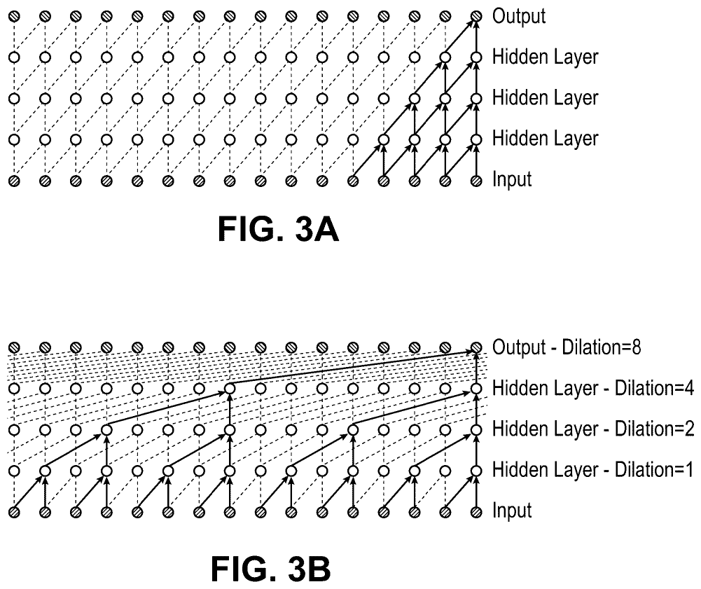

Referring again to FIGS. 1A and 1B, the model 100 (or example implementation model 100A, generally referred to as the model 100 at a high level), computes seasonality and covariance via the autoencoder 111 and trend information via the autoregressor 112. The encoder 106 component compresses the input data into a minimal representation which excludes all of the noise and contains only the real information. The encoder 106 learns a compressed representation or latent space of the input time series multivariate data shown as input data 104. In some aspects, the encoder may take a fixed length window of past time steps as input and thereby perform encoding into fixed length vector representation, shown as the layers in the encoder output 107. The encoder 106 may be a dilated convolutional neural network (CNN), dilated CNN, long short term memory network (LSTM), recurrent neural network (RNN) or other similar artificial neural network configured to gather and extract seasonality and covariance information. The layers shown as encoder output 107 analyze the input data sequence received and update their internal states at each time step, thereby summarizing the temporal information. The encoded representation shown as encoder output 107 may be passed to the decoder 108, such as via a bottleneck (not shown). The decoder 108, may be configured to receive the encoded representation output by the encoder 106, and generate future forecasted values capturing seasonality and covariance. The decoder 108, may be configured to receive the compressed information and then flatten it out, such as to a shape of same size and shape as a desired output in the output data 114, thereby generating a flattened sheet layer for each field having the same dimensions as the output as shown in the decoder output 109. The decoder 108 may be configured, in at least some aspects, to predict one future time step at a time based on previously predicted time steps such that it generates future values one step at a time and takes the previously predicted value as its input and updates its hidden states thereon. Put another way, the matrix provided at the decoder output 109 has a same shape as that of the autoregressor output 113. Thus, as noted earlier, the autoencoder 111 is specifically configured to project from past to the future. Put another way, in at least some aspects, the decoder uses its prior output as input for the next time step thereby allowing the autoencoder 111 to generate forecasts for future time steps and preferably utilizing the sliding window technique described herein. This is also achieved via convolutional network layers, examples of which are illustrated in FIG. 3A (providing a visualization of a stack of causal convolutional layers) and FIG. 3B (stack of dilated causal convolutional layers).

The autoencoder 111 may be configured to learn the covariance information between different time series by using a multivariate approach for the model such that it takes multiple input variables provided in the input data 104 into account thereby allowing to capture relationships and dependencies between them.

On the other hand, the autoregressor 112 is configured to take as input the original data and extracts the trend based on a regression model which provides an autoregressor output 113 with a series of values for each of the fields, each layer extending across a series of dates. The autoregressor 112 may also be formed of dense layers, CNN, RNN, or LSTM configured specifically for extracting trend information as described herein.

Referring again to FIGS. 1A and 1B, the layer merger 110 adds the outputs from the decoder 108 (shown as the decoder output 109) and the autoregressor output 113 to formulate merged layers shown as the output data 114. The layer merger 110 may combine the outputs from the various machine learning models 100 such as to perform one of a summing, average or vertical weighted sum to combine the trend, seasonality and covariance information captured in the decoder output 109 and the autoregressor output 113 to generate the output shown as the output data 114.

In one aspect of the embodiment of the disclosed computer method and system, the machine learning model 100 is trained on the stationarized historical transaction data (e.g. input data 104 stationarized by way of stationarizer 105) to automatically generate multivariate time-series forecasts, such as the output data 114. In one aspect, the trained model 100 utilizes, such as within the encoder 106, dilated causal convolutional layers such as those shown in FIGS. 3A and 3B, to analyze interconnections or co-variance between various variables and fields in the data points (e.g. as shown in FIG. 4C). Generally, covariance (or correlation) may be defined as a measure of linear dependence between two random variables and is thus useful in time series analysis which may only be done with multivariate models.

In example aspects of the disclosure, the machine learning model 100 may then receive scaled data as data frames based on predetermined timescales (e.g. window sizing). In one example implementation, the machine learning model 100 may then implement granger causality (e.g. via a preprocessor 101 module) for one or more feature selection processes of the deep learning model(s) in FIGS. 1A and 1B, to determine the validity of utilizing a particular variable of the input multivariate data set (e.g. as shown in FIG. 9) as provided in the input data 104 to forecast additional values for given variables in future time segments of the time series multivariate data, e.g. as may be provided in a subsequent multivariate time series data set, provided as output data 114.

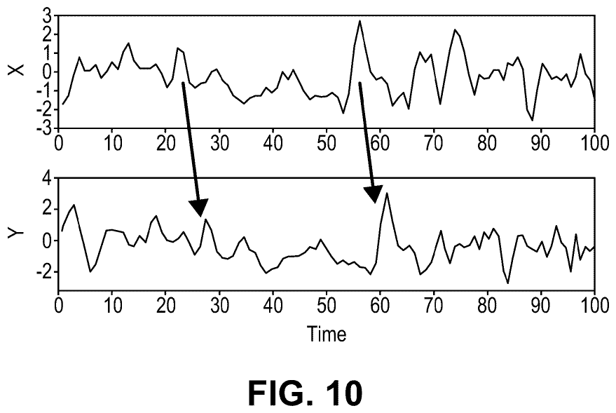

Generally, granger causality as provided by the preprocessor 101 module is a test for verifying the usefulness of one variable in forecasting another in multivariate time series data with a particular lag. Consider an example time-series graph shown in FIG. 10, variable X as depicted in the top graph of FIG. 10 has a direct influence on variable Y depicted in the bottom graph of FIG. 10 but there is a lag of 5 between X and Y in which case it would not be useful to use a simple correlation matrix to determine correlation between X and Y (see FIG. 10). Therefore, in these circumstances, granger causality is helpful (it takes the previous values of X and Y into consideration to determine correlations). The intuition behind granger causality is based on the idea that if X causes Y, then the forecast of Y based on previous values of Y AND the previous values of X should outperform the forecast of Y based on previous values of Y alone (then “X granger causes Y”). This also considers the influence of lagged observations. In at least some aspects, the machine learning model 100 is thus configured to perform granger causality feature selection via the preprocessor 101.

An aspect of the embodiment of the disclosed computer method and system, the model 100 shown in FIG. 1A (an example implementation 100A shown as the model in FIG. 1B) may be initially trained, such as by way of a sliding window via the windowing 103 block to split up the training/testing/validation data sets from the available historical time series data (see e.g. FIG. 5), and according to the various processes described herein. Then the model 100 receives current time series multivariate time series data as the input data 104. The received input data may be stationarized via the stationarizer 105. In some aspects, the input data 104 may also be preprocessed further via a preprocessor 101 to perform granger causality operations. In an additional embodiment of the disclosed computer systems and methods, the trained machine learning model 100 utilizes or more encoders 106 to predict seasonality and covariance information from the input multivariate data (e.g. as seen in FIGS. 1A and 1B). Referring again to FIGS. 1A and 1B, additional aspects of the disclosed embodiment include processing the multivariate input data, such as transaction data or weather data obtained from various sensors, or internet of things data, via a decoder 108 subsequent to the encoder 106. In an additional embodiment of the disclosed computer systems and methods, the trained machine learning model 100 utilizes or more autoregressors 112 to predict trend information from the input multivariate time series data, e.g. input data 104.

According to one or more embodiments of the disclosure, the machine learning model 100 as shown in FIGS. 1A and 1B (showing an example implementation 100A) merges the processed decoder layers, shown as decoder output 109 and autoregressor layers, shown as autoregressor output 113 to generate a merged layer output, combining the layers to provide the output data 114. The machine learning model 100 generates one or more rolling predictions of future values for the multivariate time series, through automatically outputting one or more multivariate time series forecasts, based on the merged layer output shown as output data 114.

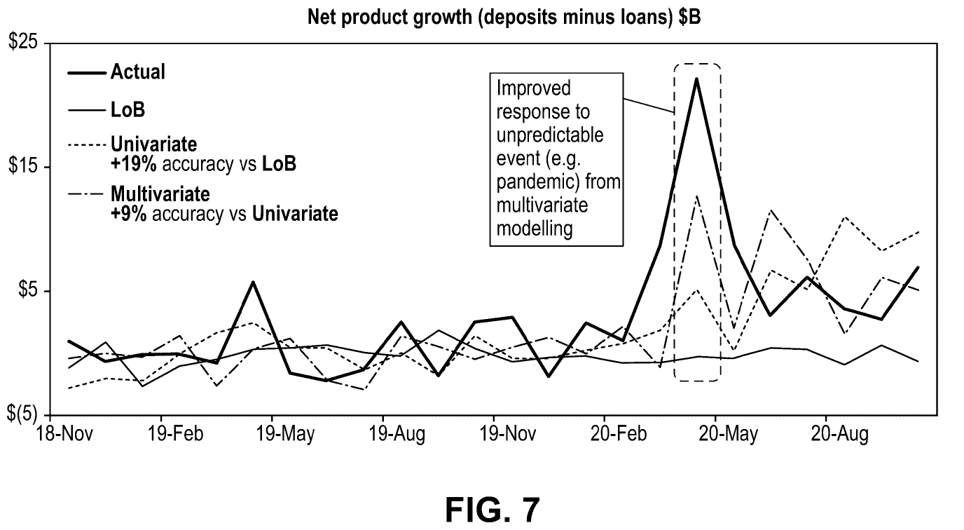

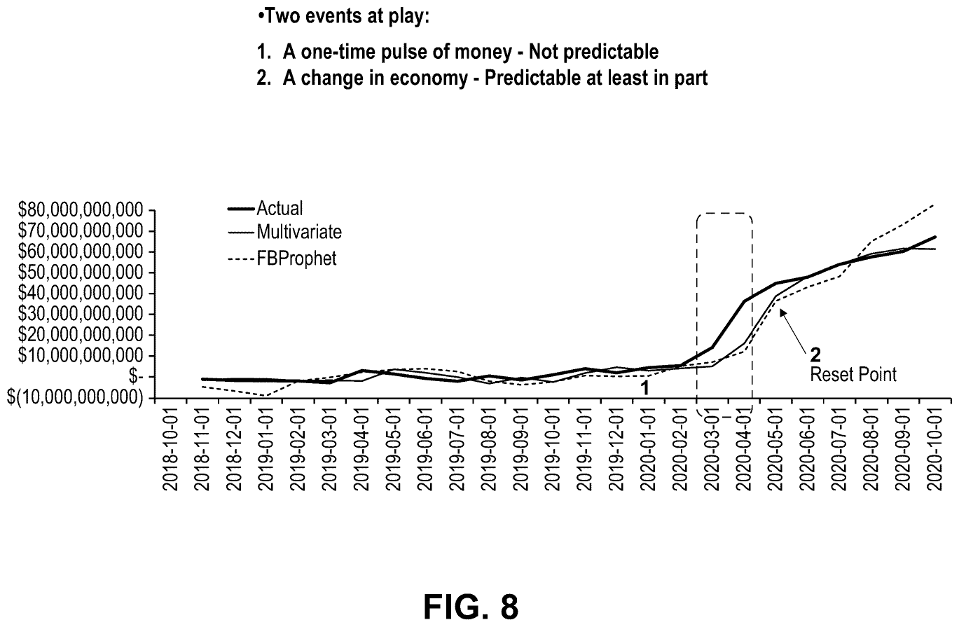

In one example embodiment, the machine learning model 100 (or example implementation 100A) of FIGS. 1A and 1B, automatically generates one or more multivariate time series forecasts on a sliding window such as that shown in FIG. 5. As shown in FIG. 5, the sliding window may be applied via the windowing 103 module which splits the input data into training and forecasting/testing based on a rolling window. The windowing technique may, in some aspects, windowing may similarly be applied during the inference stage of the machine learning model 100, such that a prior pass output of the model may be used to predict a future pass of the model and to provide fixed shaped inputs to the deep learning models such as the encoder 106. Examples of the multivariate deep learning model performance are illustrated in FIGS. 7 and 8. As shown in FIGS. 7 and 8, the disclosed multivariate machine learning model (e.g. as shown in FIGS. 1A, 1B, and 2) provides an improved performance over existing computing techniques such as univariate computing models and FBProphet model. The FBProphet model is an open source algorithm for forecasting time series data using univariate modelling. The proposed computing model provided in FIGS. 1A, 1B and 2 particularly provides improved time series forecasting when dealing with unpredictable events which may occur in a time series as shown in FIGS. 7 and 8 and thereby affect future prediction accuracy.

Multivariate time series forecasting using deep machine learning components, configured particularly and in a specialized manner as described herein to cooperate together (e.g. as shown in FIGS. 1A, 1B and 2), in at least some aspects, have the potential to exceed univariate capabilities, and the generalizable nature of this code means that there are few limits to the type of problems this can be applied to.

In at least some aspects, the disclosed model as shown in FIGS. 1A and 1B allows an improvement in the ability to track a plurality of metrics/fields or variables forward in time using multi variate deep learning forecasting with deep machine learning using artificial neural networks. No univariate model is able to make robust prediction beyond unpredictable events, such as economic transition points. See for example FIG. 7.

Conveniently, in at least some aspects, the present disclosure is directed to using the modeling capabilities of deep learning techniques to improve multivariate forecasting performance.

In at least some implementations, there is provided a computer system and method, shown as the machine learning model 100, or example implementation 100A or computing device 200, that receives and analyses multivariate time series data such as but not limited to real-time financial market data, weather data, internet of things (IoT) data, traffic management data obtained from various vehicles, network performance data, other shallow wide real time data which may be unpredictable and prone to various event interruptions, as may be communicated across multiple computing systems, servers, electronic sensors and devices in a networked environment, in order to predict future values in the time series data for the multiple input variables, via automatically generating multivariate time-series forecasts for subsequent action by the computer networked environment.

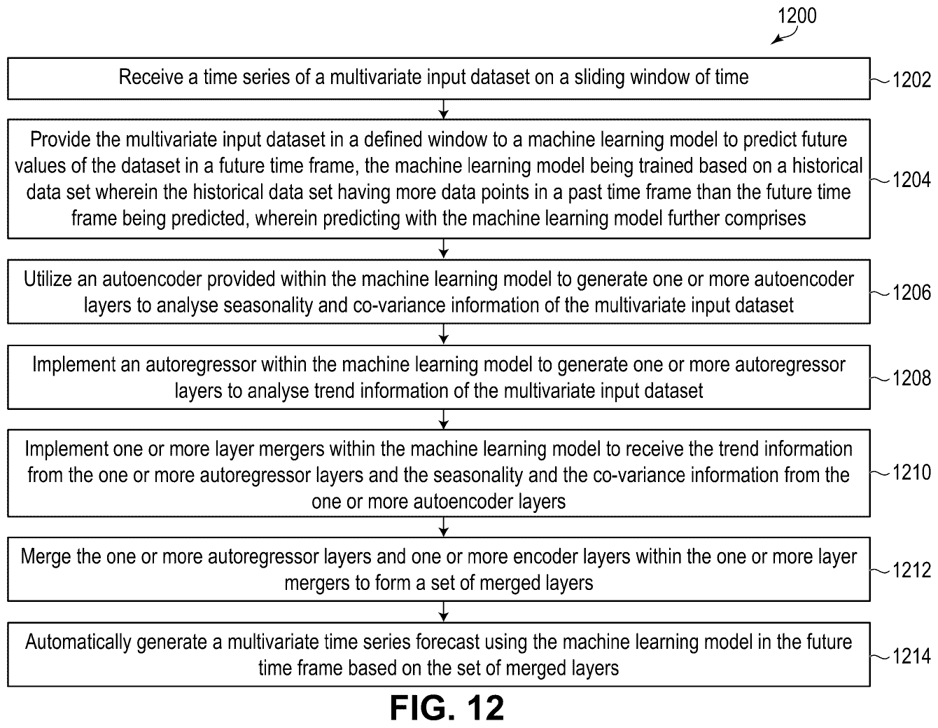

FIG. 12 illustrates an example flowchart of operations 1200 which may be performed by the machine learning model 100, the example implementation 100A and the computing device 200 implementing the machine learning models for forecasting multivariate time series data, on a computing device such as the computing device 200 for subsequent interaction. The operations 1200 are further described below with reference particular reference to FIGS. 1-11.

The computing device for carrying out the operations 1200 may comprise a processor configured to communicate with a display to provide a graphical user interface (GUI) wherein the computing device has a network interface to receive various multivariate time series input data set (e.g. such as from various other computing devices, servers, sensors, etc. which may be in communication with may be stored within a memory 102 in FIG. 1A, and wherein instructions (stored in a non-transient storage device), when executed by the processor, configure the computing device to perform operations such as operations 1200. In at least some aspects of the operation 1200, the machine learning model is a deep learning neural network for forecasting time series multivariate data based on a particular machine learning architecture for predicting seasonality, trend and covariance in the underlying data for use in forecasting future values, as depicted in FIGS. 1A and 1B.

In operation 1202, the processor receives a time series of a multivariate input dataset on a sliding window of time. During a training phase, such input data may be shown as the example in FIG. 5 and split into training/testing or forecasting data. Each pass of the data going through the model from the available historical time series data being on a rolling window to partition training/forecasting of the data. As seen in FIG. 5, a subsequent pass or iteration of the data may be time shifted compared to the prior pass with some of the data dropped based on the amount of time shift from one pass to the next. The rolling windows are of a fixed size as illustrated in FIG. 5.

In operation 1204, following operation 1202, the processor provides the multivariate input dataset in a defined window (e.g. the window of time to be used for forecasting future time values) to a machine learning model to predict future values of the dataset in a future time frame (e.g. the future time frame for forecasting). The machine learning model, e.g. machine learning model 100 or example implementation 100A are trained based on a historical data set. The historical data set may include relevant data points to indicate features such as trend, seasonality and covariance indicating relationships between input variables. As described earlier, the historical data set from which a prediction is made having more data points in a past time frame than the future time frame of the future values of the dataset being predicted.

The operations of the processor performing a prediction using the machine learning model (e.g. machine learning model 100 or example implementation 100A of FIGS. 1A, 1B and 2) further comprises: the operations 1206-1214.

Notably, at operation 1206, the operations utilize an autoencoder (e.g. the autoencoder 111 shown in FIG. 1A) provided within the machine learning model 100 to generate one or more autoencoder layers (e.g. see decoder output 109) to analyse seasonality and co-variance information of the multivariate input dataset (e.g. input data 104).

At operation 1208 following operation 1206, the operations of the processor implement an autoregressor (e.g. autoregressor 112) within the machine learning model 100 to generate one or more autoregressor layers (e.g. see autoregressor output 113) to analyse trend information of the multivariate input dataset (e.g. input data 104).

At operation 1210, following operation 1208, the operations of the processor implement one or more layer mergers (e.g. see the layer merger 110) within the machine learning model 100 to receive the trend information from the one or more autoregressor layers (e.g. autoregressor output 113) and the seasonality and the co-variance information from the one or more autoencoder layers (e.g. decoder output 109).

At operation 1212, following operation 1210, the operations of the processor further comprise merging the one or more autoregressor layers (e.g. autoregressor output 113) and one or more autoencoder layers (e.g. decoder output 109 as received from the decoder following the encoder) using the one or more layer mergers (e.g. see layer merger 110) to form a set of merged layers.

At operation 1214, following operation 1212, the operations of the processor further comprise automatically generating a multivariate time series forecast (e.g. shown at the output data 114) using the machine learning model in the future time frame based on the set of merged layers (e.g. as provided by the layer merger 110).

Benefits of utilizing the particular deep learning models in the proposed multivariate time series computerized forecasting systems, architecture and methods are numerous as shown in FIGS. 1A, 1B and 2. One advantage, in at least some aspects, lies in the ability of the disclosed particular deep learning models in the proposed computing architecture is to perform end-to-end learning, enabling them to learn directly from raw data without requiring explicit feature extraction. This adaptability is particularly valuable in domains where patterns change over time or where multiple sources of data exhibit various distributions. Moreover, the proposed deep learning computerized models scale well with large and high-dimensional datasets, ensuring their applicability to real-world scenarios. Additionally, in at least some aspects, these proposed deep learning models in the machine learning model computerized architecture demonstrate robustness in handling noisy, missing, or irregularly sampled data, making them versatile and reliable in practice. Further conveniently, the operation of the proposed machine learning model 100 as shown in FIGS. 1A, 1B and 2, allows it to be useful for shallow and wide data using the windowing and convolutional neural networks as described herein to forecast the future time series data.

FIG. 2 is a diagram illustrating in schematic form an example computing device 200 for implementing the machine learning model 100 (or example implementation 100A) of FIGS. 1A and 1B and the method of operation shown 1200 shown in FIG. 12, in accordance with one or more aspects of the present disclosure.

The computing device 200 comprises one or more processors 202, one or more input devices 204, one or more communication units 206, one or more output devices 208 and a memory 102 which may include one or more databases for storing historical multivariate time series data and data generated by the machine learning model 100. The computing device 200 also includes one or more storage devices 210 storing one or more modules such as an encoder 106, a decoder 108, a layer merger 110, windowing 103, a stationarizer 105, an autoregressor 112, and a preprocessor 101. The computing device 200 may communicate with one or more external computing devices 250, such as via a communications network (not shown for simplicity of illustration) to obtain current and historical multivariate data for forecasting, machine learning model parameters including hyperparameters. The external computing devices 250 may receive from the computing device 200, one or more forecasted multivariate time series data sequences, such as output data 114 and any metadata parameters defining the machine learning models 100 developed.

Communication channels 224 may couple each of the components 106, 108, 110, 103, 105, 112, and 101 as well as memory 102 for inter-component communications, whether communicatively, physically and/or operatively. In some examples, communication channels 224 may include a system bus, a network connection, an inter-process communication data structure, or any other method for communicating data.

One or more processors 202 may implement functionality and/or execute instructions within computing device 200. For example, processors 202 may be configured to receive instructions and/or data from storage devices 210 to execute the functionality of the modules shown in FIG. 2, among others (e.g. operating system, applications, etc.). Some of the functionality is described further below.

One or more communication units 206 may communicate with external devices, such as external computing device(s) via one or more networks (e.g. communication network) by transmitting and/or receiving network signals on the one or more networks. The communication units may include various antennae and/or network interface cards, etc. for wireless and/or wired communications.

Input and output devices may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 224).

The one or more storage devices 210 may store instructions and/or data for processing during operation of the computing device 200 such as for performing multivariate time series forecasting using the particular computing architecture of the machine learning model 100 of FIG. 1A using deep machine learning.

The one or more storage devices may take different forms and/or configurations, for example, as short-term memory or long-term memory. Storage devices 210 may be configured for short-term storage of information as volatile memory, which does not retain stored contents when power is removed. Volatile memory examples include random access memory (RAM), dynamic random access memory (DRAM), static random access memory (SRAM), etc. Storage devices 210, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Referring to FIGS. 1A, 1B and 2, the machine learning model 100 (or example implementation 100A) may comprise an application which obtains historical multivariate input data, such as input data 104, and trains the machine learning model 100 accordingly as well as monitoring for requests for forecasting of additional values of time series multivariate data such as may be received via external computing devices 250. The processes and methods for implementing the machine learning model 100 and forecasting future time series values for input multivariate time series data, such as those depicted in FIGS. 1A, 1B, and the example flow of operations shown in FIG. 12, may be implemented as computer program code and stored in the non-volatile storage, such as the memory 102 and/or storage devices 210 for execution by the processors 202, thereby causing the computing device 200 to perform time series multivariate forecasting using deep machine learning techniques specifically configured to predict seasonality, trend and covariance as described herein.

Referring again to FIG. 2, it is understood that operations may not fall exactly within the modules 101, 103, 105, 106, 108, 110, and 112 such that one module may assist with the functionality of another.

In one or more examples, the functions described may be implemented in hardware, software, firmware, or combinations thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including such media as may facilitate transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

Furthermore, the elements depicted in the flowchart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

One or more currently preferred embodiments have been described by way of example. It will be apparent to persons skilled in the art that a number of variations and modifications can be made without departing from the scope of the invention as defined in the claims.

1. A computer implemented method for providing multivariate time series forecasting of input data having multiple variables using deep learning models, the method comprising:
receiving a time series of a multivariate input dataset on a sliding window of time;
providing the multivariate input dataset in a defined window to a machine learning model to predict future values of the dataset in a future time frame, the machine learning model being trained based on a historical data set wherein the historical data set having more data points in a past time frame than the future time frame being predicted, wherein predicting with the machine learning model further comprises:
utilizing an autoencoder provided within the machine learning model to generate one or more autoencoder layers to analyse seasonality and co-variance information of the multivariate input dataset;
implementing an autoregressor within the machine learning model to generate one or more autoregressor layers to analyse trend information of the multivariate input dataset;
implementing one or more layer mergers within the machine learning model to receive the trend information from the one or more autoregressor layers and the seasonality and the co-variance information from the one or more autoencoder layers;
merging the one or more autoregressor layers and one or more autoencoder layers within the one or more layer mergers to form a set of merged layers; and,
automatically generating a multivariate time series forecast using the machine learning model in the future time frame based on the set of merged layers.

2. The method of claim 1 further comprising: stationarizing the multivariate input data as received and prior to providing the multivariate input dataset to the machine learning model.

3. The method of claim 2 wherein applying the sliding window to the multivariate input dataset of available historical time series data further comprises: designating a time portion of the time series of the multivariate input dataset as a training set for the machine learning model and another time portion of the multivariate input dataset as dropped data being ignored during a training phase of the machine learning model and a future time portion as a forecasted set for being generated by the machine learning model.

4. The method of claim 1, wherein the autoencoder of the machine learning model further comprises an encoder and a decoder, the decoder to process seasonality and co-variance information received from one or more autoencoder layers and configured to flatten layers of data provided from the encoder into a same dimension as an expected output shape from the machine learning model so as to be merged with an output of the autoregressor.

5. The method of claim 4, wherein the autoencoder is configured with a convolutional neural network to provide multivariate time series forecasting by being applied in an iterative manner wherein initially receives a window of historical time series data in the multivariate input data set for encoding and decoding, while at subsequent iterations, the decoder is tuned to use its own output as an input for a subsequent time step thereby generating forecasted seasonality and covariance for future time steps.

6. The method of claim 5, wherein the autoencoder in the machine learning model further comprises a bottleneck layer located between the encoder and the decoder, the bottleneck layer being a lower dimensional hidden layer having a least amount of neurons where the encoding is produced, and the encoder applying a dilated convolutional neural network.

7. The method of claim 1, wherein the autoencoder applies one of a dilated convolutional neural network (CNN), a long short term memory (LSTM) network, and other neural networks using convolutional layers.

8. The method of claim 1, wherein the multivariate input dataset received at the machine learning model comprises one or more multivariate time series forecasts previously automatically output by the autoencoder of the machine learning model.

9. The method of claim 1, wherein the machine learning model is further configured to perform granger causality feature selection on received input data comprising the multivariate input dataset to predict an efficacy of utilizing a particular variable of the multivariate input dataset to predict a separate forecasted multivariate time series data with a change in time period.

10. A non-transitory computer readable medium having instructions tangibly stored thereon, wherein the instructions, when executed cause a system using deep learning models to:
receive a time series of a multivariate input dataset on a sliding window of time;
provide the multivariate input dataset in a defined window to a machine learning model to predict future values of the dataset in a future time frame, the machine learning model previously trained based on a historical data set wherein the historical data set having more data points in a past time frame than the future time frame being predicted, wherein predicting with the machine learning model further comprises:
utilizing an autoencoder provided within the machine learning model to generate one or more autoencoder layers to analyse seasonality and co-variance information of the multivariate input dataset;
implementing an autoregressor within the machine learning model to generate one or more autoregressor layers to analyse trend information of the multivariate input dataset;
implementing one or more layer mergers within the machine learning model to receive the trend information from the one or more autoregressor layers and the seasonality and the co-variance information from the one or more autoencoder layers;
merging the one or more autoregressor layers and one or more autoencoder layers within the one or more layer mergers to form a set of merged layers; and,
automatically generating a multivariate time series forecast using the machine learning model in the future time frame based on the set of merged layers.

11. A computer system for providing multivariate time series forecasting of input data having multiple variables using deep learning models, the computer system comprising:
a processor in communication with a storage, the processor configured to execute instructions stored on the storage to cause the system to:
receive a time series of a multivariate input dataset on a sliding window of time;
provide the multivariate input dataset in a defined window to a machine learning model to predict future values of the dataset in a future time frame, the machine learning model being trained based on a historical data set wherein the historical data set having more data points in a past time frame than the future time frame being predicted, wherein predicting with the machine learning model further comprises:
utilize an autoencoder provided within the machine learning model to generate one or more autoencoder layers to analyse seasonality and co-variance information of the multivariate input dataset;
implement an autoregressor within the machine learning model to generate one or more autoregressor layers to analyse trend information of the multivariate input dataset;
implement one or more layer mergers within the machine learning model to receive the trend information from the one or more autoregressor layers and the seasonality and the co-variance information from the one or more autoencoder layers;
merge the one or more autoregressor layers and one or more autoencoder layers within the one or more layer mergers to form a set of merged layers; and,
automatically generate a multivariate time series forecast using the machine learning model in the future time frame based on the set of merged layers.

12. The system of claim 11 wherein the processor is configured to execute further instructions comprising: stationarizing the multivariate input data as received and prior to providing the multivariate input dataset to the machine learning model.

13. The system of claim 12 wherein applying the sliding window to the multivariate input dataset of available historical time series data further comprises the instructions configuring the processor to: designate a time portion of the time series of the multivariate input dataset as a training set for the machine learning model and another time portion of the multivariate input dataset as dropped data being ignored during a training phase of the machine learning model and a future time portion as a forecasted set for being generated by the machine learning model.

14. The system of claim 11, wherein the autoencoder of the machine learning model further comprises an encoder and a decoder, the decoder to process seasonality and co-variance information received from one or more autoencoder layers and configured to flatten layers of data provided from the encoder into a same dimension as an expected output shape from the machine learning model so as to be merged with an output of the autoregressor.

15. The system of claim 14, wherein the autoencoder is configured with a convolutional neural network to provide multivariate time series forecasting by being applied in an iterative manner wherein initially receives a window of historical time series data in the multivariate input data set for encoding and decoding, while at subsequent iterations, the decoder is tuned to use its own output as an input for a subsequent time step thereby generating forecasted seasonality and covariance for future time steps.

16. The system of claim 15, wherein the autoencoder in the machine learning model further comprises a bottleneck layer located between the encoder and the decoder, the bottleneck layer being a lower dimensional hidden layer having a least amount of neurons where the encoding is produced, and the encoder applying a dilated convolutional neural network.

17. The system of claim 11, wherein the autoencoder applies one of a dilated convolutional neural network (CNN), a long short term memory (LSTM) network, and other neural networks using convolutional layers.

18. The system of claim 11, wherein the multivariate input dataset received at the machine learning model comprises one or more multivariate time series forecasts previously automatically output by the autoencoder of the machine learning model.

19. The system of claim 11, wherein the machine learning model is further configured to perform granger causality feature selection on received input data comprising the multivariate input dataset to predict an efficacy of utilizing a particular variable of the multivariate input dataset to predict a separate forecasted multivariate time series data with a change in time period.
